(19) United States
(12) Patent Application Publication
(10) Pub. No.: US 2023/0132862 A1
(43) Pub. Date: May 4, 2023

(54) OUTDOOR COOKER AND KIT OF PARTS FOR ASSEMBLING OUTDOOR COOKER

(71) Applicant: INNER-TITE CORP., Holden, MA (US)

(72) Inventors: STEPHEN P. SPINNEY, GRAFTON, MA (US); JOHN C. MAHANEY, SPENCER, MA (US)

(73) Assignee: INNER-TITE CORP., Holden, MA (US)

(21) Appl. No.: 17/846,798

(22) Filed: Jun. 22, 2022

Related U.S. Application Data
(63) Continuation-in-part of application No. 29/813,436, filed on Oct. 28, 2021.

(51) Int. Cl. F24B 1/00; F24B 1/193; A47J 33/00; A47J 37/07

(52) U.S. Cl. CPC F24B 1/003; F24B 1/193; A47J 33/00; A47J 37/0786; A47J 2037/0795

(57) ABSTRACT

An outdoor cooker and a kit of parts for assembling an outdoor cooker are disclosed. The outdoor cooker includes a fire pit, a vertical support mechanism for coupling to the fire pit, a cooking grill for coupling to the vertical support mechanism above the fire pit, and a mechanism for coupling to the vertical support mechanism that is operative to selectively move and secure the cooking grill to a desired position along the vertical support mechanism.

### CROSS-REFERENCE TO RELATED APPLICATIONS

The present patent application claims the benefit of co-pending U.S. Design patent application Ser. No. 29/813,436 entitled “OUTDOOR STOVE,” and filed 28 Oct. 2021, of which is hereby incorporated by reference in its entirety to provide continuity of disclosure.

### BACKGROUND

Embodiments of this disclosure relate generally to fire pits, and more specifically, to a fire pit-based outdoor cooker that facilitates cooking over an open fire and/or communal gathering around the fire.

Fire pit-based outdoor cookers have increased in popularity over the past several years. Many of the currently available fire pit-based outdoor cookers are associated with a number of problems. For example, the design of these outdoor cookers typically do not provide for efficient combustion of fuels. This can lead to the formation of hazardous byproducts such as smoke and embers. Additionally, the design of many fire pit-based outdoor cookers have durability and dependability issues that limit the life span of the cookers. Further, many of these fire pit-based outdoor cookers lack versatility in that their cooking grates are fixed in position with respect to the fire. Cooking over an open fire comes with its own nuances and challenges, and a grate that is fixed in its position with respect to the fire makes it difficult to create multiple zones of heating, which can be beneficial in controlling how food is cooked over the fire. Another challenge with many of the currently available fire pit-based outdoor cookers is that these cookers are difficult to transport to and from different locations.

### BRIEF SUMMARY

The following presents a simplified summary of the disclosed subject matter in order to provide a basic understanding of some aspects of the various embodiments described herein. This summary is not an extensive overview of the various embodiments. It is not intended to exclusively identify key features or essential features of the claimed subject matter set forth in the Claims, nor is it intended as an aid in determining the scope of the claimed subject matter. Its sole purpose is to present some concepts of the disclosure in a streamlined form as a prelude to the more detailed description that is presented later.

In accordance with one embodiment, an outdoor cooker is provided. The outdoor cooker of this embodiment comprises a fire pit including a fire pit body having a top wall, a bottom wall, and a sidewall extending from the top wall to the bottom wall, the fire pit body defining an opening in an interior of the fire pit body that extends through the top wall and the bottom wall between the sidewall to form a bottomless fire pit; a vertical support mechanism secured to the fire pit at the sidewall of the fire pit body, the vertical support mechanism extending upward beyond the top wall; a cooking grill coupled to the vertical support mechanism above the fire pit, the cooking grill rotatable about the vertical support mechanism with a rotatable displacement that ranges from a position where the cooking grill is in vertical alignment with the opening of the fire pit body to a position where the cooking grill extends beyond a periphery of the top wall of the fire pit body; and means for selectively moving and securing the cooking grill to a position along the vertical support mechanism, the selectively moving and securing means coupled to the vertical support mechanism with the cooking grill placed thereon, wherein the selectively moving and securing means is configured to slidably move along the vertical support mechanism uninhibited and engage with the vertical support mechanism to lock the selectively moving and securing means in place against the vertical support mechanism.

In accordance with another embodiment, an outdoor cooker is provided. The outdoor cooker of this embodiment comprises a fire pit including a fire pit body having a top wall, a bottom wall, and a sidewall extending from the top wall to the bottom wall, the fire pit body defining an opening in an interior of the fire pit body that extends through the top wall to the bottom wall between the sidewall; a pole secured to the fire pit at the sidewall of the fire pit body near the bottom wall, the pole extending vertically upward from the sidewall to beyond the top wall; a pole clamp configured for slidable movement and engagement with the pole, the pole clamp vertically slidable along the pole in an unclamped state and secured in a fixed position with the pole in a clamped state; and a cooking grill configured for placement on the pole clamp, wherein the pole clamp is configured to translate the cooking grill along the pole and secure the cooking grill to the pole at a desired height in relation to the fire pit

In accordance with third embodiment, a kit of parts for assembling an outdoor cooker is provided. The kit of parts in this embodiment comprises a fire pit including a fire pit body having a top wall, a bottom wall, and a sidewall extending from the top wall to the bottom wall, the fire pit body defining an opening in an interior of the fire pit body that extends through the top wall and the bottom wall between the sidewall to form a bottomless fire pit; a pole configured for coupling to the fire pit at the sidewall of the fire pit body near the bottom wall, the coupled pole extending vertically upward from the sidewall to beyond the top wall; a pole clamp configured for coupling to the pole, the coupled pole clamp operative to slidably move and engage with the pole, wherein the pole clamp is vertically slidable along the pole in an unclamped state and secured in a fixed position with the pole in a clamped state; and a cooking grill configured for placement on the pole clamp coupled to the pole, wherein the pole clamp is configured to translate the cooking grill along the pole and secure the cooking grill to the pole at a desired height in relation to the fire pit.

### BRIEF DESCRIPTION OF THE DRAWINGS

The present invention will be better understood from reading the following description of non-limiting embodiments, with reference to the attached drawings, wherein below:

FIG. 1 is a perspective view of an outdoor cooker according to an embodiment of the invention;

FIG. 2 is a perspective view of the fire pit depicted in the outdoor cooker of FIG. 1 with the pole and pole clamp removed according to an embodiment of the invention;

FIG. 3 is a perspective view of an optional fire grate that is suitable for use with the outdoor cooker depicted in FIG. 1 according to an embodiment of the invention;

FIG. 4 is a perspective view of an outdoor cooker utilizing the fire grate depicted in FIG. 3 according to an alternative embodiment of the invention;

FIG. 5 is a perspective view of the pole and pole clamp depicted in the outdoor cookers of FIGS. 1 and 4 removed therefrom according to an embodiment of the invention;

FIG. 6 is a perspective view of the cooking grill depicted in the outdoor cookers of FIGS. 1 and 4 removed from the pole and pole clamp according to an embodiment of the invention;

FIGS. 7A-7D show various views of the pole clamp with further details according to embodiments of the invention;

FIG. 8 shows a cross-sectional side view of the pole clamp and the pole with the pole clamp in an unclamped state according to an embodiment;

FIG. 9 shows a cross-sectional side view of the pole clamp and the pole with the pole clamp in a clamped state according to an embodiment;

FIG. 10 shows a perspective view of a cooking grill/fire grate handling implement for use with the outdoor cookers depicted in FIGS. 1 and 4 according to an embodiment;

FIG. 11 shows an example of the cooking grill/fire grate handling implement depicted in FIG. 10 used to assist in adjusting the height of the cooking grill of an outdoor cooker according to an embodiment; and

FIG. 12 shows an example of the cooking grill/fire grate handling implement depicted in FIG. 10 used to assist in removing a fire grate from the fire pit of an outdoor cooker according to an embodiment.

### DETAILED DESCRIPTION

Example embodiments of the present invention will be described more fully hereinafter with reference to the accompanying drawings, in which some, but not all embodiments are shown. Indeed, the present invention may be embodied in many different forms and should not be construed as limited to the embodiments set forth herein; rather, these embodiments are provided so that this disclosure will satisfy applicable legal requirements. For like numbers may refer to like elements throughout.

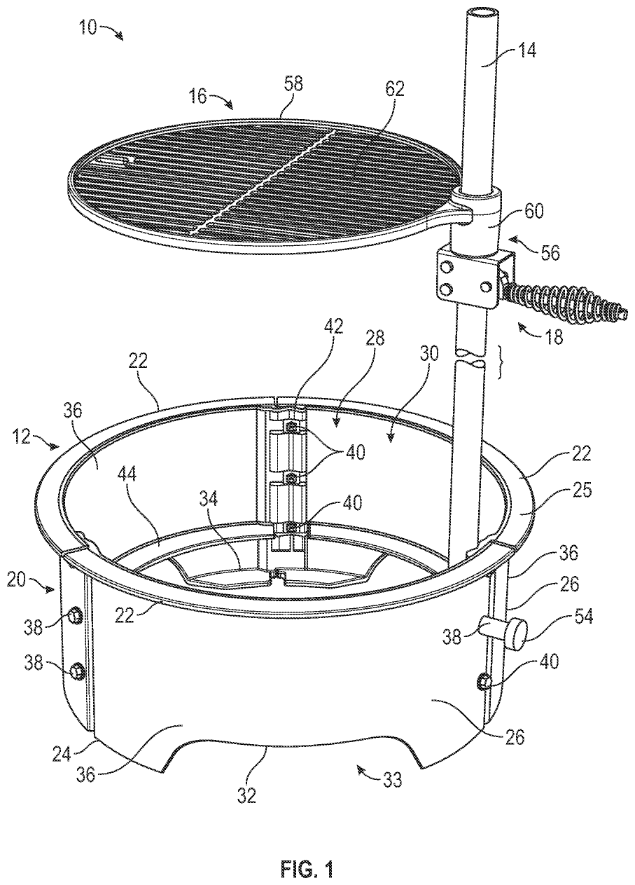

Turning now to the figures, FIG. 1 shows a perspective view of an outdoor cooker 10 according to an embodiment of the invention. In this embodiment, the outdoor cooker 10 can include a fire pit 12, a vertical support mechanism 14 secured to the fire pit, a cooking grill 16 coupled to the vertical support mechanism, and means or mechanism for selectively moving and securing 18 the cooking grill to a position along the vertical support mechanism. The fire pit 12 is sized to receive a fuel source that can include, but is not limited to firewood, charcoal, and combinations thereof. The fire pit 12 can hold a fire after Ignition of the fuel source. The open flame from the fire can cook food directly placed on the cooking grill 16 that is suspended over the fire by the vertical support mechanism 14, and secured in place by the moving and securing means 18. In addition to carrying food directly thereon, the cooking grill 16 can hold pots, pans, kettles and the like containing food that can be cooked by the open flame of the fire in the fire pit 12. In one embodiment, the cooking grill 16 is rotatable about the vertical support mechanism 14, and the moving and securing means 18 can be used to increase or decrease the height of the cooking grill with respect to the fire in the fire pit 12. In this manner, a person cooking food with the outdoor cooker 10 can control the cooking of the food by moving the cooking grill 16 in and out of the fire by rotating the grill away from the fire in the fire pit 12, and moving the cooking grill closer to or further away from the flame of the fire by raising or lowering the moving and securing means 18.

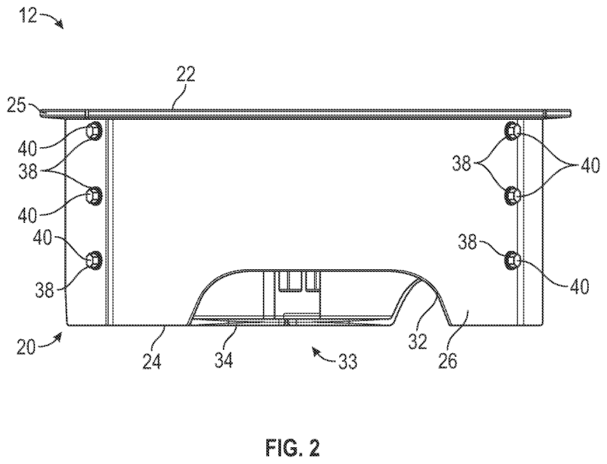

Additional details of the fire pit 12 are now described in relation to FIG. 1 and FIG. 2 which shows the fire pit with the vertical support mechanism 14 and the moving and securing means 18 removed. As shown in FIGS. 1 and 2, the fire pit 12 includes a fire pit body 20 having a top wall 22, a bottom wall 24, and a sidewall 26 extending from the top wall to the bottom wall. The fire pit body 20 defines an opening 28 in an interior 30 of the fire pit body that extends through the top wall 22 to the bottom wall 24 between the sidewall 26. In one embodiment, the opening 28 extends through the top wall 22 and the bottom wall 24 to form a bottomless fire pit. In one embodiment, as shown in FIGS. 1 and 2, the top wall 22 of the fire pit body 20 can comprise an outer rim 25 that extends laterally outward beyond a periphery of the sidewall. In this manner, the outer rim 25 can be useful in lifting and moving the outdoor cooker 10 to desired locations of use.

In one embodiment, the bottom wall 24 of the fire pit body 20 can comprise at least one upward extending region 32 that extends upwards into the sidewall 26. To this extent, the at least one upward extending region 32 defines a ventilation flue 33 that facilitates air flow in the fire pit 12. This allows the fire pit 12 to attain a hot fire with less smoke. Consequently, charcoal and wood can burn more completely in the fire pit 12 resulting in minimal ash. The number of upward extending regions 32 in the fire pit body 20 of the fire pit 12 that form a ventilation flue 33 can vary. In one embodiment, the fire pit body 20 can include three upward extending regions 32 that form a ventilation flue, however, it is understood that the fire pit 12 can include more or less. Further, it is understood that the location of the upward extending regions 32 can vary from the depictions FIGS. 1 and 2, as can the size of the regions including the width and height.

Portions of the bottom wall 24 of the fire pit body 20 that are adjacent the upward extending region 32 can form a leg 34. The number and location of the legs 34 can be dependent upon factors such as the number of upward extending regions 32 in fire pit body 20, the spacing between the upward extending regions 32, the weight of the fire pit 12, and the size of the fire pit. In one embodiment, each portion of the bottom wall 24 of the fire pit body 20 that is adjacent an upward extending region 32 can comprise at least one leg 34. To this extent, the legs 34 can facilitate stabilization of the fire pit 12 upon its placement in a desired location. As shown in FIGS. 1 and 2, the legs 34 can project inward from an inner portion of the sidewall 26 of the fire pit body 20 toward its interior 30. It is understood that the legs can be arranged in another configuration including, but not limited to, projecting outward from the sidewall 26 of the fire pit body 20, projecting both inward and outward from the sidewall, or projecting immediately below the bottom wall 24 of the fire pit body, as well as inward and outward from the sidewall in a tripod-like design. Further, it is understood that the size of the legs 34 can vary in order to accommodate different locations of placement. For example, the legs 34 can facilitate placement and stabilization on the ground including even and uneven terrain. Other locations of placement for the outdoor cooker 10 can include, but are not limited to patios and decks. However, it should be appreciated that patios and decks may not be ideal locations for placement of the outdoor cooker 10, and thus, an intermediary protective barrier may be placed between the patios/decks and the outdoor cooker.

In one embodiment, the fire pit body 20 can comprise a multi-segmented fire pit body formed from individual fire pit body sections 36. Each individual fire pit body section 36 can have a top wall 22 section, a bottom wall 24 section, and a sidewall 26 section. In addition, each of the individual fire pit body sections 36 can include at least one region with a plurality of spaced apart holes 38 that extend vertically from the bottom wall section to the top wall section along the sidewall section. The plurality of spaced apart holes 38 can receive a plurality of fasteners 40 that are adapted for placement in aligned holes of the individual fire pit body sections for coupling the fire pit body sections to form the fire pit body 12. In one embodiment, the fasteners 40 can include bolts and the holes 38 can be complementary to receive the bolts. In this manner, nuts can be used to secure the bolts in the holes. FIGS. 1 and 2 show that a vertical support mechanism alignment feature 42 can be interleaved with the holes 38 and fasteners 40 to provide structural support to the coupled individual fire pit body section used to form the fire pit 12. It is understood that other fastener configurations can be utilized, and the embodiments of the invention are not meant to be limited to any one particular arrangement.

As shown in FIG. 1, the fire pit body 20 can comprise a flange 44 that extends about an inner surface of the sidewall 26 of the fire pit body. In one embodiment, the flange 44 projects inward toward the opening 28 in the interior 30 of the fire pit body 20. The flange 44 can be located at the bottom wall 24 of the fire pit body 20 Instead of locating the flange 44 at the bottom wall 24, it is contemplated that the flange can be positioned a predetermined distance above the bottom. The size and shape of the fire pit 12 are illustrative of some of the factors that can have a role in where the flange 44 is located.

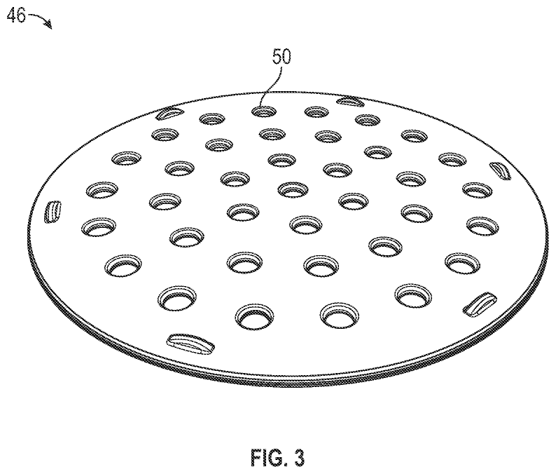

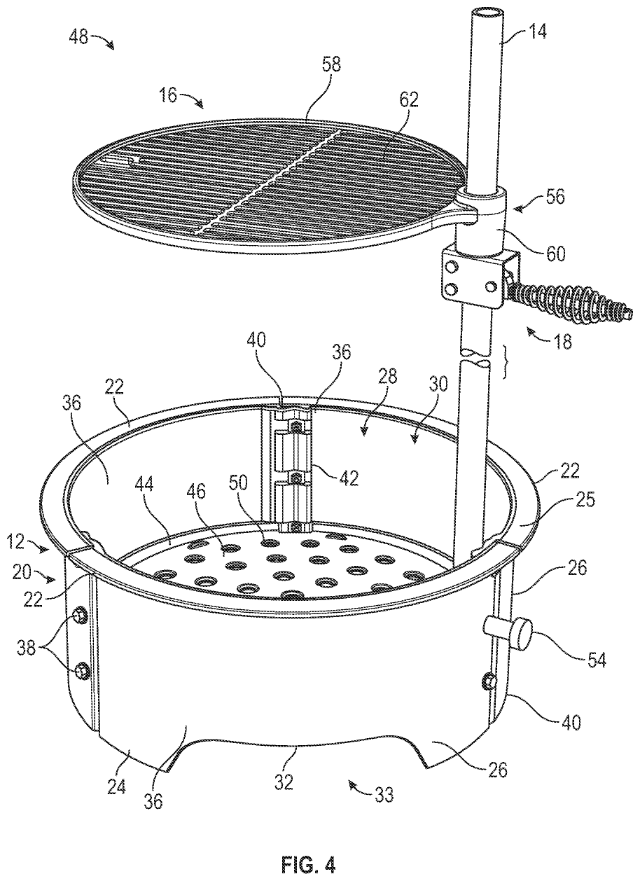

In one embodiment, a fire grate can be placed on the flange 44. In this manner, fuel such as the firewood, charcoal, and the like can be placed on top of the fire grate. Placement of the fire grate on the flange 44, as opposed to on the ground with the bottomless fire pit, will complement the flue ventilations and facilitate even more flow air flow to obtain a hot fire with less smoke. FIG. 3 shows an example of a fire grate 46 that can be placed on the flange 44, and FIG. 4 shows an outdoor cooker 48 according to an alternative embodiment of the invention in which the fire grate is in use with the fire pit 12. As shown in FIGS. 3 and 4, the fire grate 46 can include a plurality of openings 50 to promote air flow during burning of the fuel source. Although the fire grate 46 is depicted with openings 50, it is understood that other configurations can be utilized including, but are not limited to, aperture, slits, slots, and the like. Further, it is understood that the pattern and spacing of the openings that are associated with the fire grate 46 are illustrative of one example and are not meant to be limiting to the embodiments described herein. In one embodiment, the fire grate 46 can have a diameter that is about 18.75 inches. In one embodiment, the fire grate 46 can be made of solid cast iron. It is understood that the sizes and material used to form the fire grate are variable.

It is appreciated that the fire pit 12 can be made from any of a number of materials, and sized and shaped according to a multiple of arrangements in order to attain a configuration that is suitable for cooking various amounts of food and cooking accessories, as well providing heat to those that gather around the outdoor cooker for warmth as in a campfire scenario. In one embodiment, the fire pit 12 can comprise solid cast iron with a baked enamel finish. In one embodiment, the fire pit 12 of the outdoor cookers 10 and 48 can have a height of 10 inches, an inner diameter of 21.5 inches, and an outer diameter of 24 inches. Although the fire pit 12 of the outdoor cookers 10 and 48 are depicted in the figures as round, it is understood that other shapes, such as for example, square, octagonal, etc., can be utilized. These materials, dimensions and shapes are only illustrative and it is understood that these characteristics may be varied to the extent they preserve the ability of the outdoor cookers described herein to cook and be utilized in a camp fire scenario for communal gathering and socialization.

As shown with the outdoor cookers 10 and 48 depicted in FIGS. 1 and 4, respectively, the vertical support mechanism 14 is secured to the fire pit 12 at the sidewall 26 of the fire pit body 20. In this arrangement, the vertical support mechanism 14 can extend upward from the bottom wall 24 of the fire pit 12 adjacent the sidewall 26 and beyond the top wall 22. The vertical support mechanism 14 can take the form of any of a number of structures that can be coupled to the fire pit 12 and that have the capability to support the cooking grill 16 and any food and cooking accessories including but not limited to, pots, pans and kettles. A non-exhaustive list of structures that are suitable for use as a vertical support mechanism 14 with the outdoor cookers 10 and 48 include, but are not limited to, a pole, a post, a bar, a rod, a pipe, and the like. These structures can be made from any of a number of materials and can be sized with height and thickness criteria as desired. In one embodiment as illustrated in the figures, the vertical support mechanism 14 can comprise a pole. For purposes of clarity in corresponding with the figures, the description that follows will equate the pole with reference element 14 used to designate the vertical support mechanism. It is understood that the above list of structures and equivalents thereof can be interchanged with the pole to represent the vertical support mechanism 14. Further, these structures can be formed from any of a number of materials including, but not limited to, stainless steel, and can be sized with a desired length such as for example 31 inches.

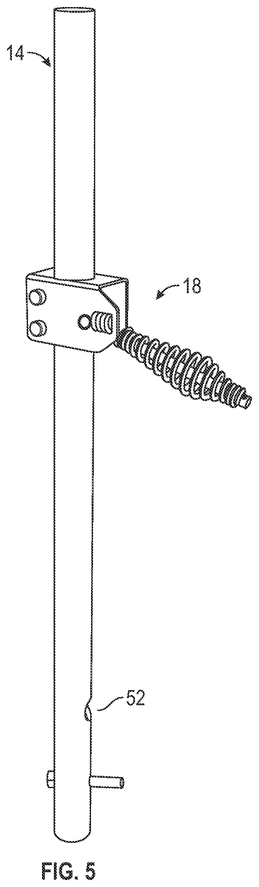

In one embodiment, as shown in FIGS. 1 and 4, the pole 14 can be mounted in the interior of the fire pit 12, secured to the top wall 22, the bottom wall 24, and the sidewall 26 of the fire pit body 20. FIG. 5, which illustrates the pole 14 and the moving and securing means 18 removed from the outdoor cookers 10 and 48 of FIGS. 1 and 4, respectively, shows that the pole can have a region that includes a pole hole 52 formed therethrough. One of the spaced apart holes 38 in one of the fire pit body sections 36 can serve as a pole mating hole that is configured to facilitate mounting of the pole 14 with the fire pit body 20 of the fire pit 12. Any of the aforementioned fasteners (e.g., a bolt and nut assembly) can be used in conjunction with the pole hole 52 and the hole 38 serving as the pole mating hole to secure the pole 14 to the sidewall 26 of the fire pit body 20. For example, upon aligning the holes, the fastener can be inserted through the holes and fastened to secure the pole 14 to the fire pit body 20.

In one embodiment, as shown in FIGS. 1 and 4, instead of using a nut to secure the bolt inserted through the holes of the pole 14 and the sidewall 26, a built-in hex wrench tool 54 can be used that is configured to receive the bolt therein and be tightened to engage with the bolt. In this manner, the built-in hex wrench tool 54 can be complementary to receive the bolt and used to tighten the bolt as it engages with the bolt in order to secure the pole 14 to the fire pit 12. In one embodiment, the built-in hex wrench tool 54 can be made with a 9/16 hex machined into the working surface and formed of brass, however, it is understood other materials can be used.

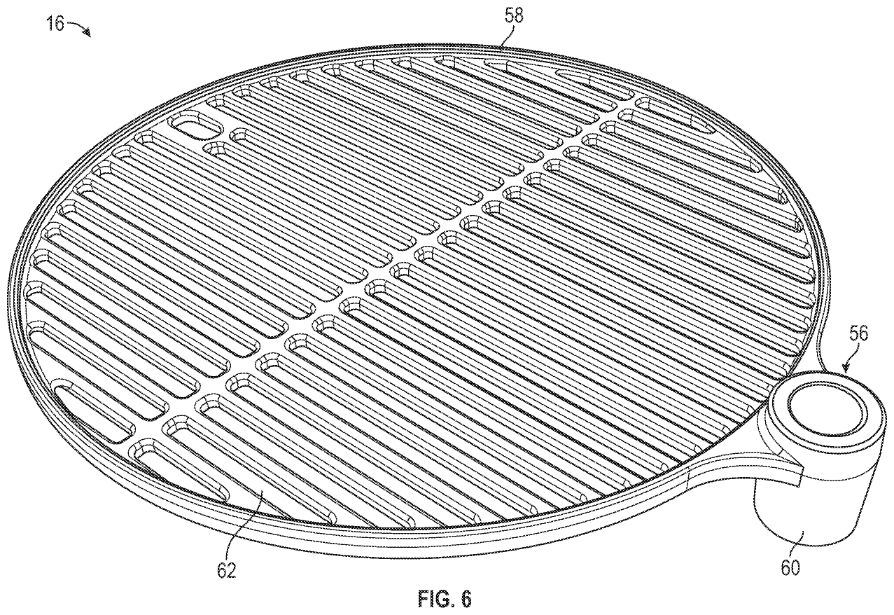

With the pole 14 coupled to the fire pit 12, the cooking grill 16 can be secured to the pole via the moving and securing means 18 placed above the fire pit 12. For example, in one embodiment, the cooking grill 16 can be placed on top of the moving and securing means 18 and suspended over the fire pit 12. In this manner, the flame of any fire contained in the fire pit 12 can be used to cook any food on the cooking grill 16 or in any pots, pans, kettles, and the like placed on the grill. Further details of the cooking grill 16 are now described in relation to FIGS. 1 and 4, and FIG. 6 which shows the grill removed from the pole 14 and the moving and securing means 18. In one embodiment, the cooking grill 16 can comprise a rotatable support sleeve 56 configured for fitting over the pole 14 and a grate 58 coupled to an outer surface 60 of the rotatable support sleeve. The rotatable support sleeve 56 can rotate about the circumference of the pole 14. In this manner, the grate 58 can be displaced in and out of a flame associated with any fire in the fire pit 12. This range of displacement covers a position where the cooking grill 16 is in vertical alignment with the opening 28 of the fire pit body 20 to a position where the cooking grill extends beyond a periphery of the top wall 22 of the fire pit body. Also, the grate 58 can be rotated and flipped about the support sleeve 56. With all this range of motion that is provided, the grate 58 can swing out and away from the fire, so that one can load, flip and serve the food away from the direct heat of the fire.

The grate 58 can be configured in any of a number of designs that facilitate the heating and cooking of food and cooking implements placed thereon. In one embodiment, the grate 58 defines a plurality of openings 62. The openings 62 of the grate 58 can take the form of one of a number of designs including, but not limited to, a welded grid of spaced bars, sections of expanded metal, and the like. In one embodiment, the grate 58 can comprise solid cast iron, however, it is understood that other materials may be utilized.

As noted above, the selectively moving and securing 18 means can move the cooking grill 16 up and down the pole 14 to a desired position or positions on the pole to accommodate the nuances and complexities of controlling the cooking under a flame of an open fire in the fire pit 12. In one embodiment, the moving and securing means 18 is configured to slidably move along the pole 14 uninhibited and engage with the pole to lock the moving and securing means in place against the pole. The moving and securing means 18 can take the form of any of a number of structures that can be used to translate up and down the pole 14, as well as support the cooking grill 16 while moving up and down the pole, and further be secured and locked in placed in a desired position with the pole, all while being able to support any food and implements placed on the grill. A non-exhaustive list of structures that are suitable for use as the moving and securing means 18 include, but are not limited to, a pole clamp, a cam device, locking pins, a fastening device and the like. These structures can be made from any of a number of materials and can be sized as appropriate for the design.

In one embodiment, as shown in FIGS. 1, 4, and 5, the moving and securing means 18 can comprise a pole clamp configured for slidable movement and engagement with the pole 14. For purposes of clarity in corresponding with the figures, the description that follows will equate the pole clamp with reference element 18 that is used to designate the moving and securing means 18. It is understood that the above list of structures and equivalents thereof can be interchanged with the pole clamp to represent the moving and securing means 18. Further, these structures can be formed from any of a number of materials including, but not limited to, stainless steel, and be sized as deemed appropriate for the particular design.

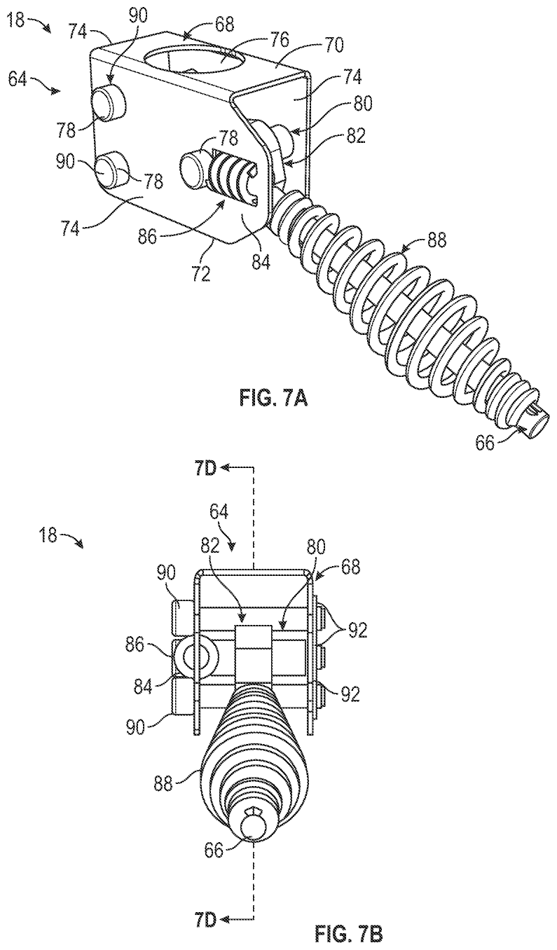

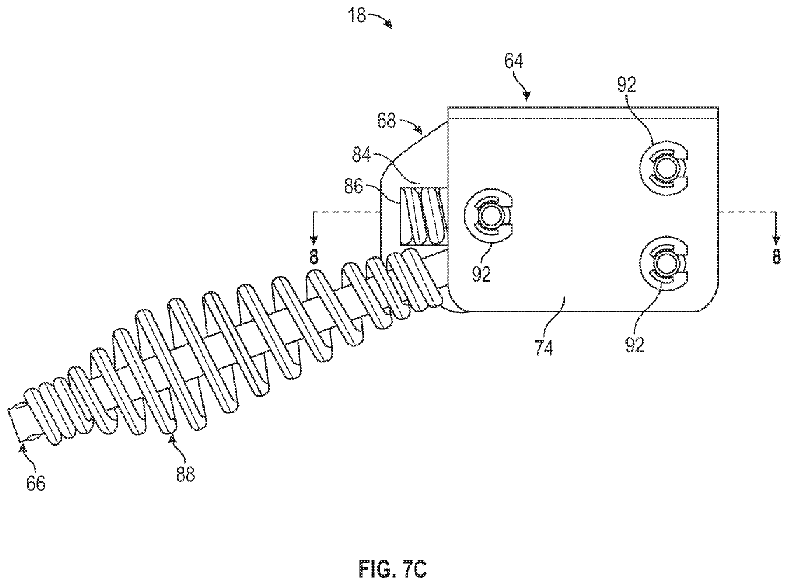

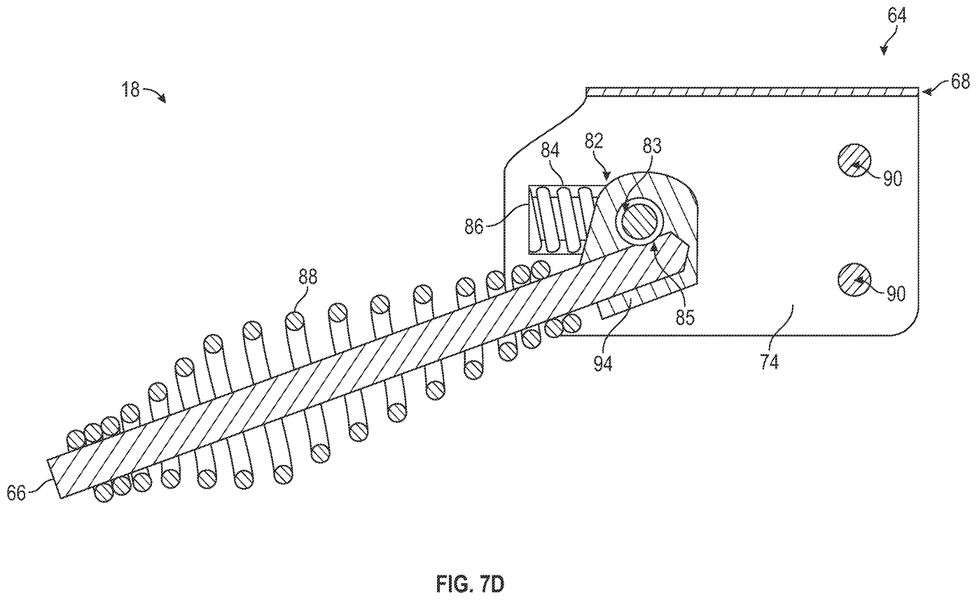

In operation, the pole clamp 18 is vertically slidable along the pole 14 in an unclamped state and secured in a fixed position with the pole in a clamped state. With the cooking grill 16 placed on the pole clamp 18, the clamp can translate the cooking grill along the pole and secure the grill to the pole at a desired height in relation to the fire pit 12. FIGS. 7A-7D, 8 and 9 depict further details of the pole clamp 18. In one embodiment, as shown in FIGS. 7A-7D, the pole clamp 18 is a clamp assembly that can comprise a clamp bracket 64 that is operative to receive the pole 14, slidably move about the pole and engage therewith. A clamp handle 66 can be coupled to the clamp bracket 64 to translate the clamp bracket along the pole 14 in an unclamped state and secure the clamp bracket in a fixed position with the pole in a clamped state.

The clamp bracket 64 can include a clamp bracket body 68 having a top wall 70, a bottom wall 72, and sidewalls 74 extending from the top wall to the bottom wall. As shown in FIG. 7A, the clamp bracket body 68 can have an opening 76 that extends through the top wall 70 and the bottom wall 72 between the sidewalls 74 to define a bore that is operative to receive the pole 14 therethrough. In one embodiment, the clamp bracket body 68 comprises a plurality of clamp bracket body openings 78 formed in a pair of opposing sidewalls 74 of the clamp bracket body. Each of the clamp bracket body openings 78 in a sidewall can be in alignment with corresponding clamp bracket body openings in the opposing sidewall of the clamp bracket body. In one embodiment, as shown in FIG. 7A and FIG. 7B, a clamp spacer bar 80 can extend through one of the pairs of aligned clamp bracket body openings 78 in the sidewalls 74. A clamp cam 82 can be coupled to the clamp spacer bar 80 with rotatable engagement therewith. In one embodiment, as shown in FIG. 7D, the clamp cam 82 can have a hole 83 through which the clamp spacer bar 80 extending from one sidewall 74 of the clamp bracket body 68 to the opposing sidewall passes through. A bushing 85 in the hole of the clamp cam 82 can facilitate rotation of the cam about the clamp spacer bar 80 during movement of the clamp handle 66.

As shown in FIGS. 7A, 7B and 7C, one of the sidewalls 74 of the pair of opposing sidewalls of the clamp bracket body 68 can comprise a slot 84 adjacent one of the openings 78. In one embodiment, the slot 84 is adjacent an opening 78 that receives the clamp spacer bar 80. In this manner, a spring 86 can be located in the slot 84 so that the spring is adjacent the clamp spacer bar 80 and the clamp cam 82. In one embodiment, the spring 86 can include a die spring. It is understood that other types of springs are possible, and the choice of such other springs can depend on the size of the slot in the clamp.

FIGS. 7A and 7B show that one of the sidewalls 74 of the clamp bracket body 68 is open-ended. As shown in these figures, the open-ended sidewall 74 of the clamp bracket body 68 is transversely oriented to the pair of opposing sidewalls of the clamp bracket body having the plurality of clamp bracket body openings 78. The clamp handle 66 can be coupled to the clamp cam 82 and the clamp spacer bar 80 through the open-ended sidewall 74 of the clamp bracket body 68. In this manner, the clamp handle 66 can project outward from the open-ended sidewall 74 of the clamp bracket body 68. As shown in FIGS. 7A, 7B, 7C, 7D, 8 and 9, a clamp handle spring 88 can be placed over the clamp handle 66 to reduce handle operating temperatures. In one embodiment, the clamp handle spring 88 can extend axially over and circumferentially around the clamp handle 66.

The clamp bracket 64 can further include at least one clamp pin 90 adapted for placement through one of the pairs of aligned clamp bracket body openings 78 in the sidewalls 74 of the clamp bracket body 68. In one embodiment, as shown in FIGS. 7A, 7B, 7D, 8 and 9, the clamp bracket 64 can include two clamp pins 90. For example, the clamp pins 90 can be located about the pair of opposing sidewalls 74 at a region that is distal to the open-ended sidewall 74 through which the clamp handle is coupled to the clamp spacer bar 80. The clamp pins 90 can also be transversely oriented to the opening 76 in the clamp bracket body 68, proximal the sidewall 74 of the clamp bracket body 68 that opposes the open-ended sidewall. In this manner, the clamp pins 90 can facilitate up and down translation of the pole clamp 18 to the pole 14 that is imparted by the clamp handle 66 in the unclamped state. In one embodiment, as shown in FIGS. 7B and 7C, clips 92 can be placed around one end of the clamp pins 90, as well as one end of the clamp spacer bar 80 to facilitate the retention of the pins and the spacer bar with the sidewalls 74 of the clamp bracket body 68. For example, the clips 92 can include circlips such as e-clips, c-clips, and the like. It is understood that the use of the pins 90 and the clips 92 are illustrative of only one configuration and those skilled in the art will appreciate that other elements may be used to effectuate the design of the pole clamp 18.

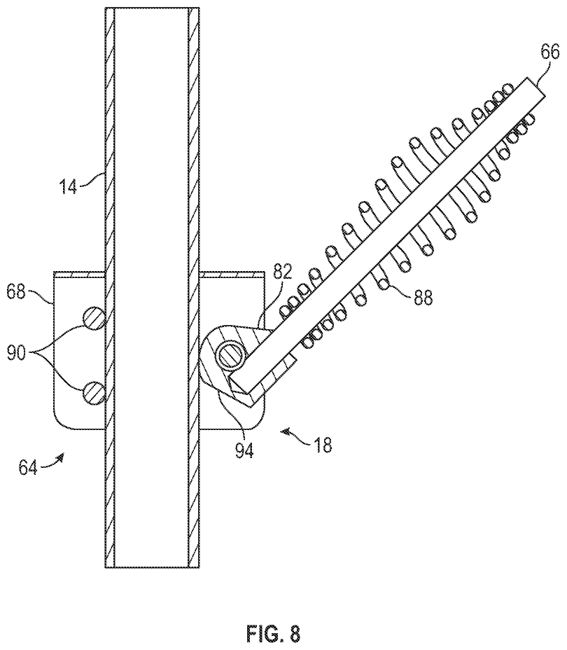

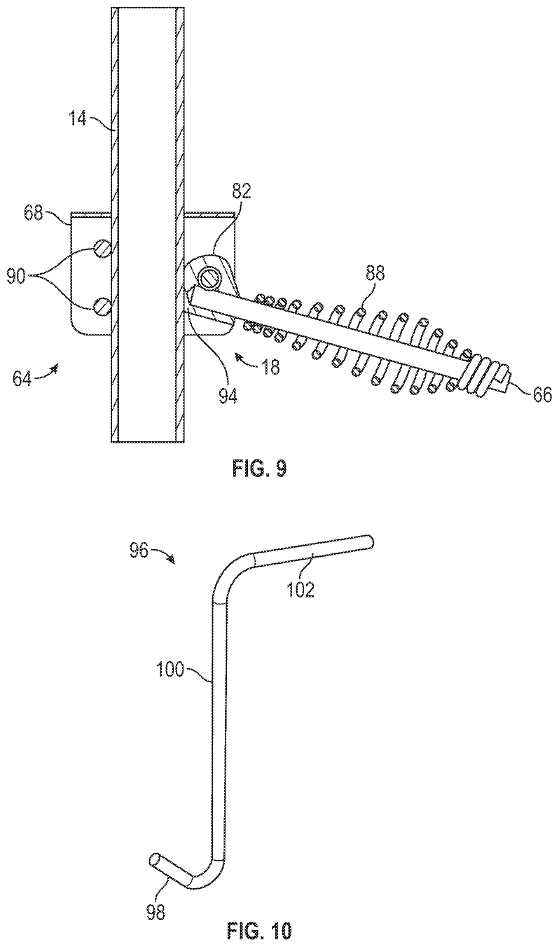

Operation of the pole clamp 18 in relation to the pole 14 is now described with respect to FIGS. 8 and 9. As noted above, the clamp handle 66 can place the pole clamp 18 in the unclamped state or the clamped state with respect to the pole 14. In FIG. 8, which shows the pole clamp 18 in the unclamped state, the clamp handle 66 moves the clamp cam 82 away from the pole 14. In this manner, a flat surface region 94 of the clamp cam is moved away from the pole 14. This allows the pole clamp 18 to translate up or down the pole 14, letting a user lift and lower the cooking grill 16 that can be supported by the pole clamp to maintain desired cooking temperature, a necessity when cooking over an open flame fire. Once a desired location for the pole clamp 18 has been reached, the clamp handle 66 can put the pole clamp in the clamped state so that the clamp is held in place securely against the pole 14.

As shown in FIG. 9, which depicts the pole clamp 18 in the clamped state, the clamp handle 66 rotates the clamp cam 82 to have contact with the pole 14. In this manner, the clamp cam 82 compresses the spring 86 as the clamp cam contacts the pole 14. In one embodiment, the flat surface region 94 of the clamp cam 82 abuts against the pole 14. As a result, further rotation of the clamp cam 82 is impeded upon the flat surface region 94 abutting against the pole 14, locking the pole clamp 18 in place against the pole. During the clamped state, the compressed spring 86 applies a constant force to the pole 14 through the clamp cam 82. This allows the pole clamp 18 to compensate for any tolerances or irregularities of the pole 14.

Although the description heretofore has been generally directed to the outdoor cookers 10 and 48 depicted in FIGS. 1 and 4, and their corresponding components which are discussed in relation to FIGS. 2, 3, 5, 6, 7A-7D, 8 and 9, another embodiment of the present invention can include a kit of parts for assembling an outdoor cooker. The kit of parts can include the components that an end user can assemble at a time of use to yield an operational ready outdoor cooker. In one embodiment, the kit of parts for assembling an outdoor cooker can comprise a fire pit 12, a pole 14 configured for coupling to the fire pit, a pole clamp 18 configured for coupling to the pole, and a cooking grill 16 configured for placement on the pole clamp coupled to the pole. As noted above with respect to FIGS. 1, 2, and 4, the fire pit 12 can include a fire pit body 20 having a top wall 22, a bottom wall 24, and a sidewall 26 extending from the top wall to the bottom wall. In one embodiment, the fire pit body can define an opening 28 in an interior 30 of the fire pit body 20 that extends through the top wall 22 and the bottom wall 24 between the sidewall 26 to form a bottomless fire pit.

The pole 14, when coupled to the sidewall 26 of the fire pit body 20 near the bottom wall 24, can extend vertically upward and beyond the top wall 22. With the pole clamp 18 coupled to the pole 14, the pole clamp is vertically slidable along the pole in an unclamped state and secured in a fixed position with the pole in a clamped state. In this manner, the cooking grill 16 when placed on the pole clamp 18, can be translated up and down the pole 14. Adjusting the pole clamp 18 and thus the height of the cooking grill 16, allows the end-user to maintain a desired cooking temperature during the cooking or heating of any food or food implements may be placed on the cooking grill.

The kit of parts for assembling the outdoor cooker can also include a fire grate 46 configured for placement in the interior 30 of the fire pit body 20 of the fire pit 12. In one embodiment, the fire grate 46 which is depicted in FIGS. 3 and 4, can be placed on the flange 44 that extends about the interior of the fire pit 12. This allows the user to place a fuel source such as charcoal on the fire grate 46 with or without any fire wood. The openings 50 in the fire grate 46 along with the ventilation flue 33 promote a hotter fire with less smoke. This allows the charcoal and the wood to burn more completely with minimal resultant ash.

The aforementioned components of the kit of parts for assembling the outdoor cooker are illustrative of only a sample of components and is not meant to be limiting as it is understood that the kit could include other components that can facilitate the use of the assembled outdoor cooker for either cooking purposes or gathering around the cooker for warmth and socialization. For example, in one embodiment, the kit can include a cooking grill/fire grate handling implement.

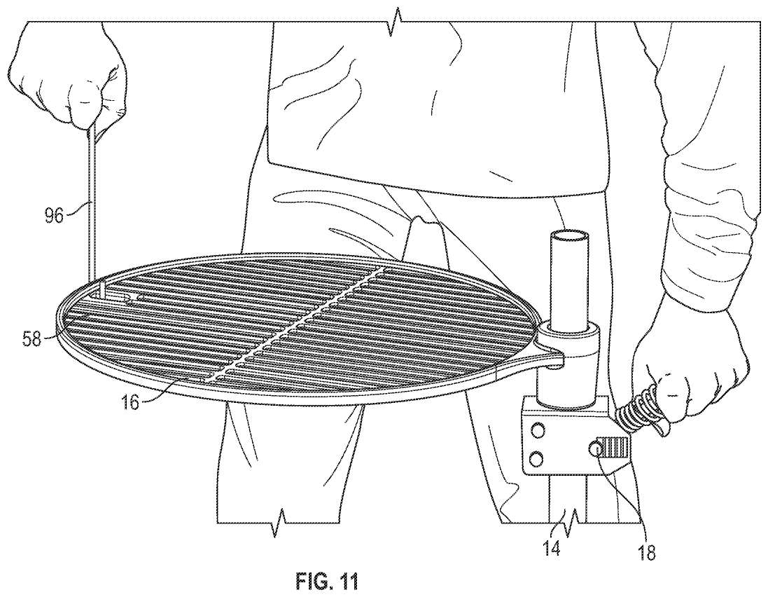

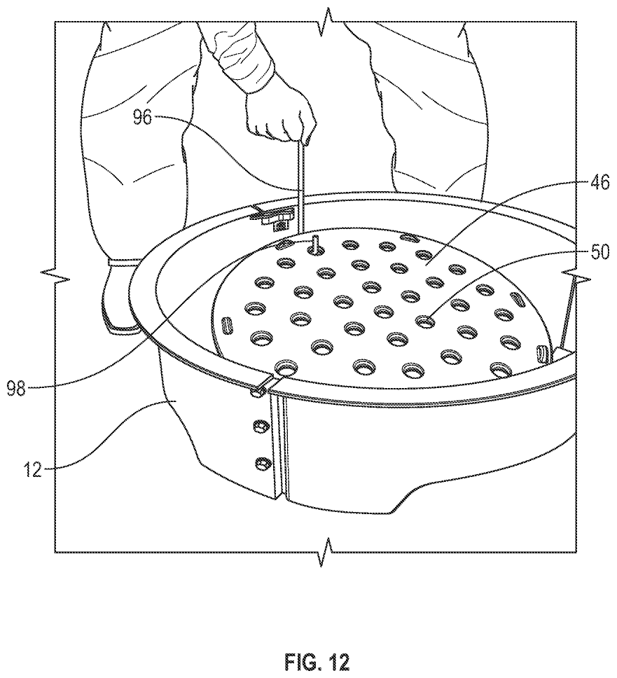

FIG. 10 shows a perspective view of a cooking grill/fire grate handling implement 96 that can facilitate the lifting and lowering of the cooking grill 16 along with the pole clamp 18, and removal of the fire grate 46 from the fire pit 12. In one embodiment, the cooking grill/fire grate handling implement 96 for use with the outdoor cookers depicted in FIGS. 1 and 4 can include a grate hook that is configured for securing to the grate 58 of the cooking grill 16 and the fire grate 46. As shown in FIG. 10, the grate hook can include a barb 98, a shank portion 100, and a handle portion 102. To this extent, the grate hook can be secured to the grate 58 of the cooking grill 16 or to any of the openings 62 in the grate 58 via the barb 98. FIG. 11 shows an example of a user with the grate hook secured to the grate 58 of the cooking grill 16 in one hand, while the other hand is adjusting the height of the pole clamp 18 on the pole 14. In this manner, the user can securely adjust the height of the cooking grill 16 with respect to a flame of a fire in a fire pit below the grill. FIG. 12 shows an example of a user grasping the handle portion 102 (not shown in FIG. 12) of the grate hook with the barb 98 secured to one of the openings 50 in the fire grate 46. In this manner, the grate hook facilitates the removal of a hot fire grate 46 from the fire pit 12.

In one embodiment, the cooking grill/fire grate handling implement 96 can be formed from stainless steel. It is understood that the cooking grill/fire grate handling implement 96 can be formed from other materials. Furthermore, it is understood that the cooking grill/fire grate handling implement 96 depicted in FIG. 10 represents one option and is not meant to be limiting as it is appreciated that other designs are possible.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize. For example, parts, components, steps and aspects from different embodiments may be combined or suitable for use in other embodiments even though not described in the disclosure or depicted in the figures. Therefore, since certain changes may be made in the above-described invention, without departing from the spirit and scope of the invention herein involved, it is intended that all of the subject matter of the above description shown in the accompanying drawings shall be interpreted merely as examples illustrating the inventive concept herein and shall not be construed as limiting the invention.

In this regard, while the disclosed subject matter has been described in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below. For example, references to “one embodiment” of the present invention are not intended to be interpreted as excluding the existence of additional embodiments that also incorporate the recited features.

In the appended claims, the terms “including” and “in which” may be used, and if so, are used as the plain-English equivalents of the respective terms “comprising” and “wherein.” Moreover, in the following claims, terms such as “first,” “second,” “third,” “upper,” “lower,” “bottom,” “top,” etc. are used merely as labels, and are not intended to impose numerical or positional requirements on their objects. The terms “substantially,” “generally,” and “about” indicate conditions within reasonably achievable manufacturing and assembly tolerances, relative to ideal desired conditions suitable for achieving the functional purpose of a component or assembly. Further, the limitations of the following claims are not written in means-plus-function format and are not intended to be interpreted as such, unless and until such claim limitations expressly use the phrase “means for” followed by a statement of function void of further structure.

What has been described above includes examples of systems and methods illustrative of the disclosed subject matter. It is, of course, not possible to describe every combination of components or methodologies here. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings, such terms are intended to be inclusive in a manner similar to the term “comprising” as “comprising” is interpreted when employed as a transitional word in a claim. That is, unless explicitly stated to the contrary, embodiments “comprising,” “including,” or “having” an element or a plurality of elements having a particular property may include additional such elements not having that property. Moreover, articles “a” and “an” as used in the subject specification and annexed drawings should generally be construed to mean “one or more” unless specified otherwise or clear from context to be directed to a singular form.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

1. An outdoor cooker, comprising:
a fire pit including a fire pit body having a top wall, a bottom wall, and a sidewall extending from the top wall to the bottom wall, the fire pit body defining an opening in an interior of the fire pit body that extends through the top wall and the bottom wall between the sidewall to form a bottomless fire pit;
a vertical support mechanism secured to the fire pit at the sidewall of the fire pit body, the vertical support mechanism extending upward beyond the top wall;
a cooking grill coupled to the vertical support mechanism above the fire pit, the cooking grill rotatable about the vertical support mechanism with a rotatable displacement that ranges from a position where the cooking grill is in vertical alignment with the opening of the fire pit body to a position where the cooking grill extends beyond a periphery of the top wall of the fire pit body; and
means for selectively moving and securing the cooking grill to a position along the vertical support mechanism, the selectively moving and securing means coupled to the vertical support mechanism with the cooking grill placed thereon, wherein the selectively moving and securing means is configured to slidably move along the vertical support mechanism uninhibited and engage with the vertical support mechanism to lock the selectively moving and securing means in place against the vertical support mechanism.

2. The outdoor cooker of claim 1, wherein the bottom wall of the fire pit body comprises at least one upward extending region that extends upwards into the sidewall, the at least one upward extending region defining a ventilation flue that facilitates air flow in the fire pit.

3. The outdoor cooker of claim 2, wherein portions of the bottom wall of the fire pit body that are adjacent to the at least one upward extending region form a leg.

4. The outdoor cooker of claim 1, wherein the fire pit body comprises a multi-segmented fire pit body formed from individual fire pit body sections, each individual fire pit body section having a top wall section, a bottom wall section, a sidewall section, and at least one region with a plurality of spaced apart holes that extend vertically from the bottom wall section to the top wall section along the sidewall section.

5. The outdoor cooker of claim 4, further comprising a plurality of fasteners adapted for placement in the plurality of spaced apart holes of the individual fire pit body sections for coupling the fire pit body sections to form the fire pit body.

6. The outdoor cooker of claim 1, wherein the fire pit body comprises a flange that extends about an inner surface of the sidewall, the flange projecting inward toward the opening in the interior of the fire pit body, wherein the flange is located about the bottom wall of the fire pit body.

7. The outdoor cooker of claim 6, further comprising a fire grate configured for placement on the flange to receive a fuel source, wherein the fire grate comprises a plurality of openings to promote air flow during burning of the fuel source.

8. The outdoor cooker of claim 1, wherein the selectively moving and securing means is a clamp assembly comprising a clamp bracket operative to receive the vertical support mechanism, slidably move about the vertical support mechanism and engage therewith, and a clamp handle coupled to the clamp bracket to translate the clamp bracket along the vertical support mechanism in an unclamped state and secure the clamp bracket in a fixed position with the vertical support mechanism in a clamped state.

9. The outdoor cooker of claim 1, wherein the fire pit and the cooking grill is formed from a material comprising solid cast iron.

10. An outdoor cooker, comprising:
a fire pit including a fire pit body having a top wall, a bottom wall, and a sidewall extending from the top wall to the bottom wall, the fire pit body defining an opening in an interior of the fire pit body that extends through the top wall to the bottom wall between the sidewall;
a pole secured to the fire pit at the sidewall of the fire pit body near the bottom wall, the pole extending vertically upward from the sidewall to beyond the top wall;
a pole clamp configured for slidable movement and engagement with the pole, the pole clamp vertically slidable along the pole in an unclamped state and secured in a fixed position with the pole in a clamped state; and
a cooking grill configured for placement on the pole clamp, wherein the pole clamp is configured to translate the cooking grill along the pole and secure the cooking grill to the pole at a desired height in relation to the fire pit.

11. The outdoor cooker of claim 10, wherein the pole clamp comprises a clamp bracket including a clamp bracket body having a top wall, a bottom wall, and sidewalls extending from the top wall to the bottom wall, the clamp bracket body having an opening that extends through the top wall and the bottom wall between the sidewalls to define a bore that is operative to receive the pole therethrough.

12. The outdoor cooker of claim 11, wherein the clamp bracket body comprises a plurality of clamp bracket body openings formed in a pair of opposing sidewalls of the clamp bracket body, each of the clamp bracket body openings in a sidewall is in alignment with corresponding clamp bracket body openings in the opposing sidewall of the clamp bracket body.

13. The outdoor cooker of claim 12, further comprising a clamp spacer bar extending through one of the pairs of aligned clamp bracket body openings in the sidewalls.

14. The outdoor cooker of claim 13, further comprising a clamp cam coupled to the clamp spacer bar with rotatable engagement therewith.

15. The outdoor cooker of claim 14, wherein one of the sidewalls of the pair of opposing sidewalls of the clamp bracket body comprises a slot adjacent one of the openings, the slot adjacent the opening that receives the clamp spacer bar.

16. The outdoor cooker of claim 15, further comprising a spring located in the slot, the spring adjacent the clamp spacer bar and the clamp cam.

17. The outdoor cooker of claim 16, wherein one of the sidewalls of the clamp bracket body is open-ended, the open-ended sidewall of the clamp bracket body is transversely oriented to the pair of opposing sidewalls of the clamp bracket body having the plurality of clamp bracket body openings.

18. The outdoor cooker of claim 17, further comprising a clamp handle coupled to the clamp cam and the clamp spacer bar, the clamp handle projecting outward from the open-ended sidewall of the clamp bracket body.

19. The outdoor cooker of claim 18, wherein the clamp handle is operative to place the pole clamp in the unclamped state or the clamped state.

20. The outdoor cooker of claim 19, wherein the clamp handle in the unclamped state is configured to move the clamp cam away from the pole, allowing the pole clamp to translate up or down the pole to a desired location by holding onto the clamp handle.

21. The outdoor cooker of claim 19, wherein the clamp handle in the clamped state is configured to rotate the clamp cam to have contact with the pole, the clamp cam compressing the spring as the clamp cam contacts the pole, the compressed spring applying a constant force to the pole through the clamp cam, allowing the pole clamp to compensate for any tolerances or irregularities of the pole.

22. The outdoor cooker of claim 21, wherein the clamp cam comprises a flat surface region, the flat surface region of the clamp cam abutting against the pole in the clamped state, wherein further rotation of the clamp cam is impeded upon the flat surface region abutting against the pole, locking the pole clamp in place against the pole.

23. The outdoor cooker of claim 18, further comprising a clamp handle spring extending axially over and circumferentially around the clamp handle.

24. The outdoor cooker of claim 20, further comprising at least one clamp pin adapted for placement through one of the pairs of aligned clamp bracket body openings in the sidewalls of the clamp bracket body, wherein the at least one clamp pin facilitates up and down translation of the pole clamp to the pole that is imparted by the clamp handle in the unclamped state.

25. The outdoor cooker of claim 10, wherein the cooking grill comprises a rotatable support sleeve configured for fitting over the pole and a grate coupled to an outer surface of the rotatable support sleeve, wherein rotation of the rotatable support sleeve about the pole facilitates rotatable displacement of the grate from a position that is in vertical alignment with the fire pit to a position that is offset from the fire pit.

26. The outdoor cooker of claim 25, further comprising a grate hook configured to secure to the grate and assist in the slidable movement of the pole clamp and the cooking grill about the pole.

27. A kit of parts for assembling an outdoor cooker, comprising:
a fire pit including a fire pit body having a top wall, a bottom wall, and a sidewall extending from the top wall to the bottom wall, the fire pit body defining an opening in an interior of the fire pit body that extends through the top wall and the bottom wall between the sidewall to form a bottomless fire pit;
a pole configured for coupling to the fire pit at the sidewall of the fire pit body near the bottom wall, the coupled pole extending vertically upward from the sidewall to beyond the top wall;
a pole clamp configured for coupling to the pole, the coupled pole clamp operative to slidably move and engage with the pole, wherein the pole clamp is vertically slidable along the pole in an unclamped state and secured in a fixed position with the pole in a clamped state; and
a cooking grill configured for placement on the pole clamp coupled to the pole, wherein the pole clamp is configured to translate the cooking grill along the pole and secure the cooking grill to the pole at a desired height in relation to the fire pit.
